(19) United States
(12) Patent Application Publication
(10) Pub. No.: US 2013/0043305 A1
(43) Pub. Date: Feb. 21, 2013

(54) METHODS AND SYSTEMS FOR RECEIVING COMPENSATION FOR USING MOBILE PAYMENT SERVICES

(71) Applicants: Tiger T. G. Zhou, Tiburon, CA (US); Dylan T. X. Zhou, San Gabriel, CA (US); Andrew H. B. Zhou, Tiburon, CA (US)

(72) Inventors: Tiger T. G. Zhou, Tiburon, CA (US); Dylan T. X. Zhou, San Gabriel, CA (US); Andrew H. B. Zhou, Tiburon, CA (US)

(21) Appl. No.: 13/661,207

(22) Filed: Oct. 26, 2012

Related U.S. Application Data
(63) Continuation-in-part of application No. 13/185,491, filed on Jul. 18, 2011.

(51) Int. Cl. G06Q 30/02

(52) U.S. Cl. 235/381

(57) ABSTRACT

Provided are methods and systems for receiving compensation for using mobile payment services. A customer may register with a mobile payment service provider and provide customer payment information. Based on the customer payment information, the customer may receive a unique code which may be scanned by a scanner of a merchant to transfer payment for products. Additionally, to encourage the customer to further use mobile payment services, the customer may receive a compensation which may be provided according to predetermined criteria. Based on the compensation, the customer may receive a free mobile device from the mobile payment service provider. A high amount of the compensation may entitle the customer to receive free insurance services and free bank services from a bank of the mobile payment service provider. Furthermore, the mobile device received from the mobile payment service provider may be also repaired or exchanged free of charge.

### CROSS-REFERENCE TO RELATED APPLICATIONS

This application is a continuation-in-part of U.S. patent application Ser. No. 13/185,491, entitled “FACILITATING MOBILE DEVICE PAYMENTS USING PRODUCT CODE SCANNING,” filed on Jul. 18, 2011, which is incorporated herein by reference in its entirety.

### FIELD

This application relates generally to payment methods using mobile devices in various retail environments and, more specifically, to computer implemented methods and systems for receiving compensation for using mobile payment services.

### BACKGROUND

When customers buy product items from various merchants in these merchants' retails environments, such as retail outlets, shopping centers, stores, etc., only a handful of payment methods is available to the customers. Typical examples include credit cards, debit cards, gift cards, checks, and cash. Each one of these payment methods has some drawbacks from cost and/or convenience perspectives. For example, credit cards bear substantial processing fees, while debit cards require availability of funds and sometimes involve surcharges as well. Checks and cash transactions are slow and require additional processing and/or handling. All these drawbacks interfere with retail transactions and add some level of dissatisfaction.

At the same time, a customer typically visits the same group of stores repeatedly, and these payment transaction fees tend to accumulate. While some stores try to issue their own credit-like account systems and employ banks to help them in this endeavor (e.g., Sears—Chase VISA), many stores are simply too small to build and operate systems similar to the ones provide by the major credit card companies and/or banks.

Furthermore, a typical customer repeatedly visits multiple retail outlets. Requiring the customer to continuously carry multiple retail cards (or other security/transactional devices) each one being specific to only one of these outlets may be difficult, if not unreasonable. For example, a typical customer may use a few gas stations (e.g., depending on his location), a few grocery stores (e.g., depending on preferences), a few electronic stores (e.g., depending on current sales and promotions). Complexities introduced by store specific account systems may quickly offset any costs savings or inconvenience associated with traditional methods of payments and may make the overall experience even worse.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are methods and systems for receiving compensation for using mobile payment services. In general, these methods and systems are designed to facilitate mobile device payments and provide incentives for customers to use the mobile payment services.

According to the methods and systems disclosed herein, upon registration with a mobile payment service provider, a customer may specify his payment information and receive a unique code that may be scanned by a scanner of a merchant to transfer funds for a purchase. Besides, when providing a bank checking account as the payment information or when participating in affiliate marketing, loyalty programs or group buying offers made by a mobile network operator or a mobile device company, the customer may be provided with a compensation which may entitle him to receive a free mobile device from the mobile payment service provider. Additionally, the customer may also receive free services associated the mobile device received free of charge from the mobile payment service provider.

### BRIEF DESCRIPTION OF DRAWINGS

Embodiments are illustrated by way of example and not limitation in the figures of the accompanying drawings, in which like references indicate similar elements and in which:

FIG. 1 is a block diagram illustrating an example of the overall system, in accordance with certain embodiments.

FIG. 2 is a block diagram showing various modules of the payment processing system, in accordance with certain embodiments.

FIG. 3A is a flow chart illustrating a method for facilitating mobile device payments using a barcode displayed on a mobile device, in accordance with certain embodiments.

FIG. 3B is a flow chart illustrating a payment processing method using a merchant payment system, in accordance with certain embodiments.

FIG. 4A illustrates a computer system within which a set of instructions for causing the machine to perform any one or more of the methodologies discussed herein is executed, in accordance with certain embodiments.

FIG. 4B illustrates an example of a mobile device, in accordance with certain embodiments.

FIG. 5 is a flow chart illustrating a method for receiving compensation for using mobile payment services, in accordance with certain embodiments.

FIG. 6 is a block diagram illustrating an example of overall system for receiving compensation for using mobile device payment services, in accordance with certain embodiments.

### DETAILED DESCRIPTION

Various computer implemented methods and systems for facilitating mobile device payments using barcodes are described herein. Recent proliferation of mobile devices (e.g., cell phones/smart phones and other similar devices) that are capable of generated and displaying various optical codes (e.g., barcodes) allows implementing these novel methods and systems. Most customers shopping in today's retail environments carry such mobiles devices.

Product codes are typically provided as barcodes, such as linear barcodes and two dimensional barcodes, as well as human readable alphanumeric codes. For example, the Universal Product Code (UPC) or European Article Number (EAN) may be used. UPC is a barcode symbology widely used in North America and other countries for tracking trade items in stores. Its most common form, the UPC-A, consists of 12 numerical digits, which are uniquely assigned to each individual trade/product item. Each UPC-A barcode consists of a scannable strip of black bars and white spaces, above a sequence of 12 numerical digits. No letters, characters, or other content of any kind may appear on a standard UPC-A barcode. The digits and bars maintain a one-to-one correspondence. In other words, there is only one way to represent each 12-digit number visually, and there is only one way to represent each visual barcode numerically. EAN is another example developed as a superset of UPC and adding an extra digit to the beginning of every UPC number. An EAN-13 barcode, a 13 EAN barcoding standard, also indicates the country in which the company that sells the product is based using leading digits. EAN and UPC barcodes are currently the only barcodes allowed for scanning trade/product items at the point of sale. However, other codes may be available in the future and within the scope of this document.

One having ordinary skills in the art would understand that the term “scanning” is not limited to printed codes having particular formats but may be used for codes encoded electronically and using various other means. For example, product codes may be in a form of the recently developed Electronic Product Code (EPC) is designed as a universal identifier that provides a unique identity for every physical object (not just a trade item category) anywhere in the world, for all time. It should be noted that EPCs are not exclusively used with RFID data carriers. They may be constructed based on reading of optical data carriers, such as linear bar codes and two-dimensional bar codes, such as Data Matrix symbols. For purposes of this document, all optical data carriers are referred herein as “barcodes.”

Scanning a barcodes may involve capturing an image of the barcode using a simple imaging device installed on a mobile device, such as a digital camera. The image may be then processed on the mobile device to retrieve corresponding product information or sent to the server for further processing. The local processing may be performed using various software installed on the mobile device. In certain embodiments, a mobile device may contain a local database to match the retrieved product information with additional information about this product. However, because of variable nature of this additional information (e.g., pricing, product description), a mobile device then typically transmits the retrieved product information to the server and then receives some additional information from the server.

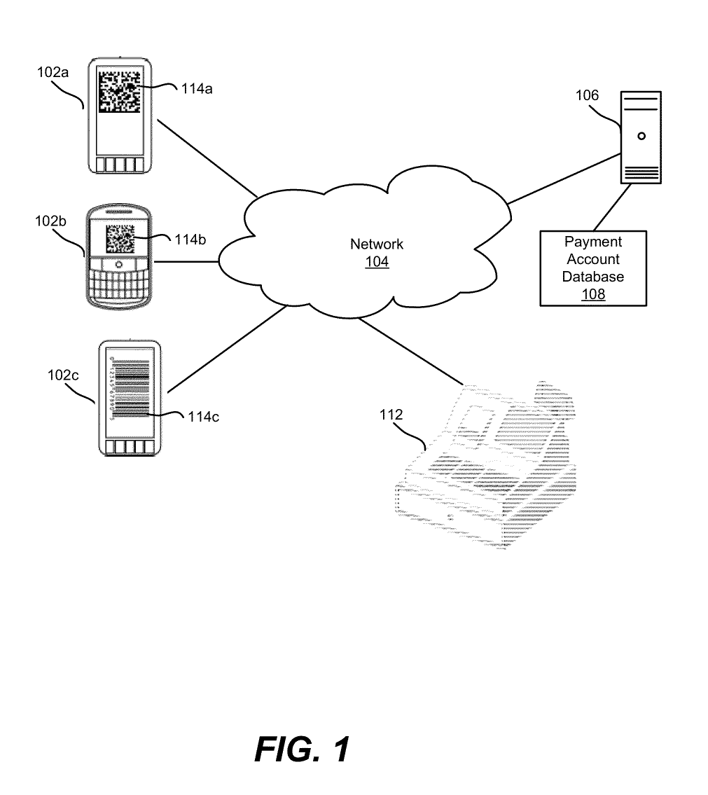

As stated, many mobile devices have wireless communication capabilities. In addition to being capable of transmitting voice-based signals, many modern cell phones have internet connectivity using cellular networks (e.g., 3G, 4G) as well as Wi-Fi and other types of networks. Some additional examples of such networks are described below with reference to FIG. 1. Wireless communication may be used to transmit retrieved product information to a payment server, receive replies, and transmit authorizations. Overall, various data may be exchanged between the mobile and payment server as well as other servers during operations of the method.

Before describing various methods and associated operations, a brief description of a computer network. Specifically, FIG. 1 illustrates an example network segment for implementing various aspects of methods and operations for facilitating mobile device payments in a retail environment using a mobile device. As shown, multiple mobile devices 102a, 102b, 102c may be configured to display barcodes 114a, 114b, and 114c. Various examples of barcodes are described above. The mobile devices 102a, 102b, 102c may include a handheld computer, a tablet computer, a personal digital assistant, a smart phone, a game console, a portable media player, a hand wrist watch phone, a wearable computer, or a glass frame computer. Mobile devices 102a, 102b, 102c communicate with payment server 106 via network 104. Payment processing server 106 is a part of the payment processing system, which may include payment account database 108 and one or more checkout counters 112. Network 104 may be also used for communication among various components of the payment processing system. Network 104 may take any suitable form, such as a wide area network or Internet and/or one or more local area networks (LAN's). The network 104 may include any suitable number and type of devices, e.g., routers and switches, for forwarding commands, content, and/or web object requests from each client to the online community application and responses back to the clients.

The methods describe herein may also be practiced in a wide variety of network environments (represented by network 104) including, for example, TCP/IP-based networks, telecommunications networks, wireless networks, etc. In addition, the computer program instructions may be stored in any type of computer-readable media. The program may be executed according to a variety of computing models including a client/server model, a peer-to-peer model, on a stand-alone computing device, or according to a distributed computing model in which various functionalities described herein may be effected or employed at different locations.

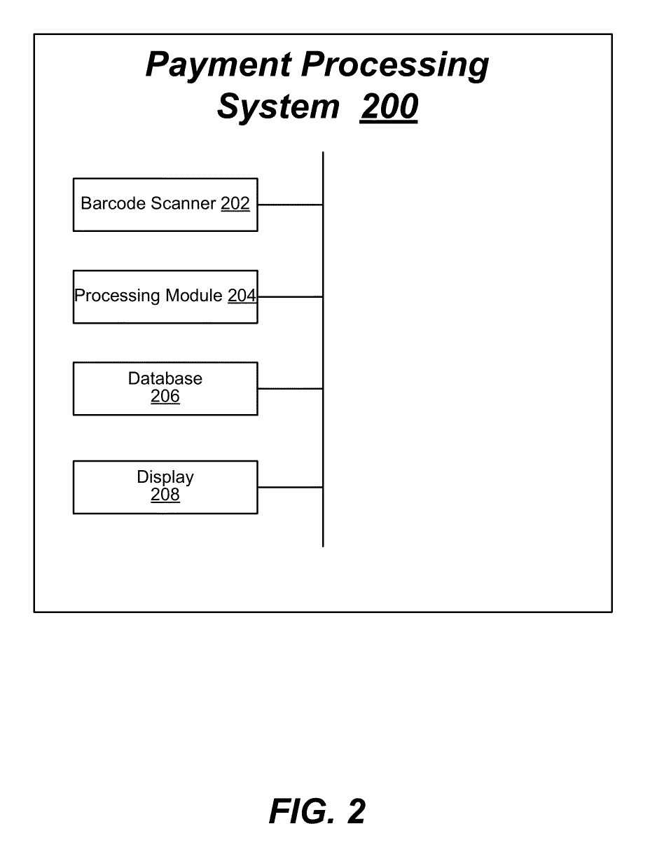

FIG. 2 is a block diagram showing various modules of payment processing system 200, in accordance with certain embodiments. Specifically, payment processing system 200 may include a barcode scanner 202 for scanning at barcode displayed on a screen of a mobile device.

Barcode scanner 202 may be provided at a checkout counter. Payment processing system 200 may also include a processing module 204 for retrieving the customer payment information from the scanned barcode. In certain embodiments, payment processing system 200 includes a database 206 for storing one or more customer records. Payment processing system 200 may also include a display 208 for displaying the one or more customer records. In certain embodiments, display 208 provided at the checkout counter together with barcode scanner 202.

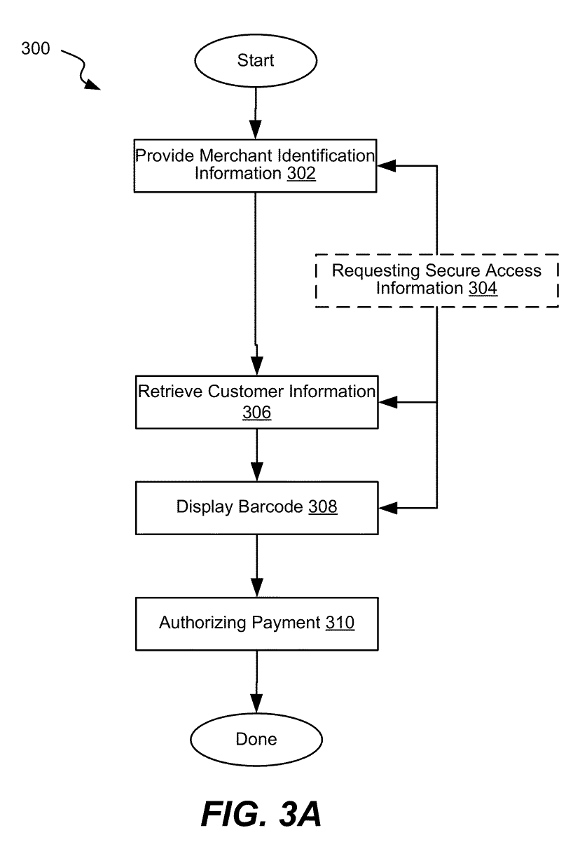

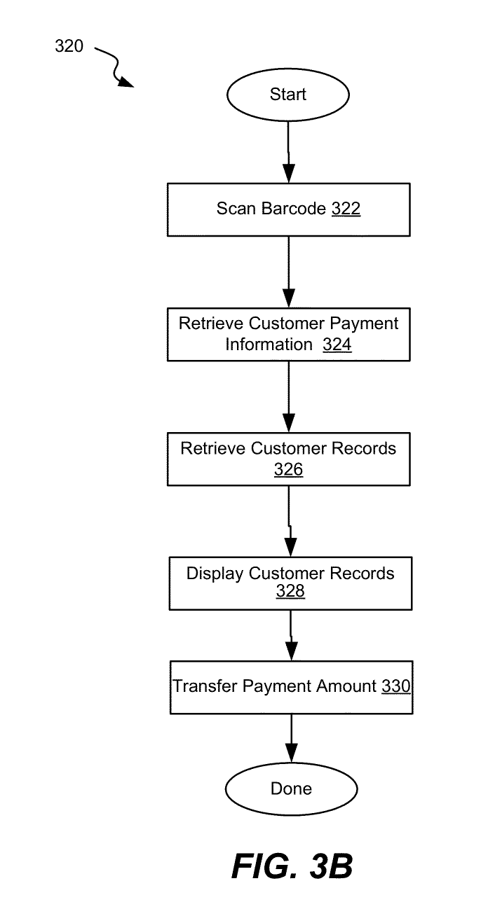

FIG. 3A is a flow chart illustrating a method for facilitating mobile device payments using a barcode displayed on a mobile device, in accordance with certain embodiments. Process 300 may start with providing merchant identification information on scanning a product code in operation 302. For example, a mobile device may be used to capture an image of the product code. This image is then processed by the mobile device to retrieve product information (e.g., UPC or EAN code) encoded in the product code. In certain embodiments, an actual image of the product code is considered being product information and it is transmitted to the payment server or some other server for further processing. In some instances, machine readable code cannot be scanned. For example, product code image provided of the product item is damaged. In these instances, a user interface of a mobile device in operation 302. The merchant identification information may correspond to a merchant payment system. For example, this operation may involve transmitting user identification information to the merchant payment system. Some examples of a mobile device include a mobile phone and a PDA. Operation 302 may also involve displaying an alphanumeric string on the screen of the mobile device. The alphanumeric string also corresponds to the customer payment information. The alphanumeric string may be used by retail clerk when the barcode is not scannable, for example.

Process 300 may proceed with retrieving customer payment information based on the merchant identification information in operation 306. The customer payment information corresponds to a customer payment account maintained at the merchant payment system. The customer payment information may be stored in a memory of the mobile device or on a secured server. Alternatively, the customer payment information may be retrieved from the merchant payment system. The customer payment information may include a customer name, a customer account number, and/or an amount of available funds.

In certain embodiments, process 300 includes an optional operation 304 performed prior to retrieving customer payment information in operation 306. Operation 304 involves requesting secure access information on the interface of the mobile device. In certain embodiments, a mobile device includes a user interface for entering an alphanumeric entry corresponding to the merchant identification information.

Process 300 also involves displaying a barcode on a screen of the mobile device in operation 308. The displayed barcode is scannable by a barcode scanner of the merchant payment system. This barcode encodes the customer payment information. It may be a linear barcode or a two-dimensional barcode.

FIG. 3B is a flow chart illustrating a payment processing method using a merchant payment system, in accordance with certain embodiments. Process 320 involves scanning a barcode displayed on a screen of a mobile device during operation 322. As stated above, the displayed barcode encodes customer payment information. This operation may be performed at a checkout counter. Process 320 may proceed with retrieving the customer payment information from the scanned barcode in operation 324. This operation may involve decoding the barcode and retrieving various data string from the barcode. Customer payment information may be used to determine availability of funds. In other embodiments, availability of funds is determined from customer records retrieve in operation 326 described below.

Process 320 may then proceed with retrieving one or more customer records from a database of the merchant payment system in operation 326. These records correspond to the customer payment information. Process 320 may then process with displaying the one or more customer records at the checkout counter in operation 328. Process 320 may involve transferring a payment amount from a customer account to a merchant account in operation 330. This operation may also involve updating the one or more customer records based on the transferred payment amount. Process 320 may also involve receiving user identification information from the mobile device and, based on the user identification information, transmitting the customer payment information to the mobile device.

Process 300 may involve transmitting the product information to the payment server in operation 306. Some Examples of product information include alphanumeric representation corresponding to UPC, EAN, EPC, and other types of codes. This product information may be then correlated to the product related data by the payment server further describe below with reference to FIG. 3B.

Process 300 may involve receiving and displaying product related information in operation 308. Some examples of product related information include product pricing information, product discount information, product description information, and complementary product information.

Finally, process 300 also involves authorizing payment in operation 310. The authorization is transmitted to the payment server and may be used for transferring funds between accounts and/or other purposes (e.g., authorizing credit).

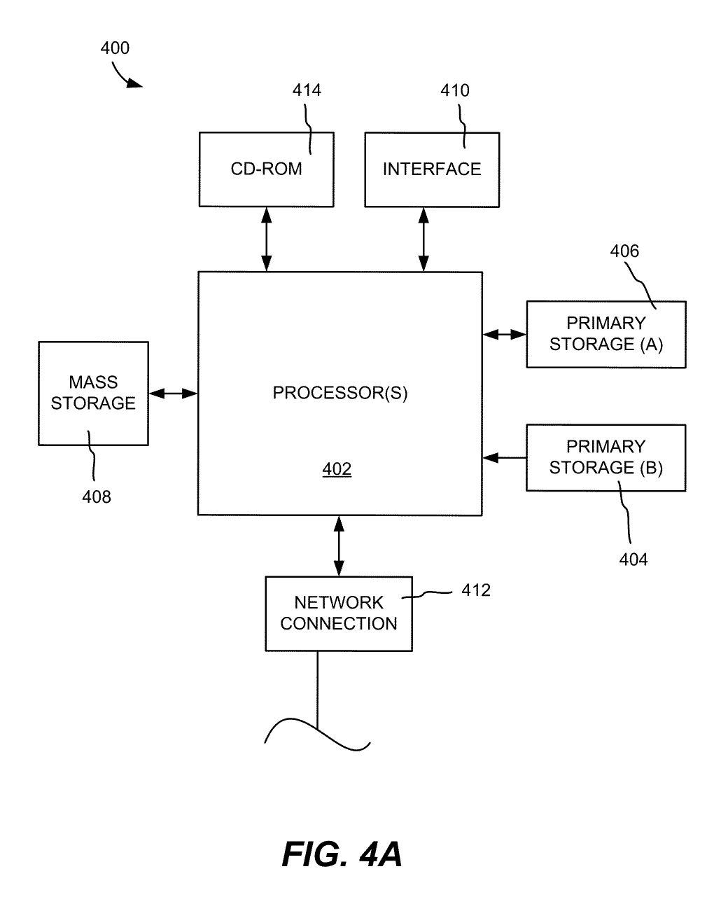

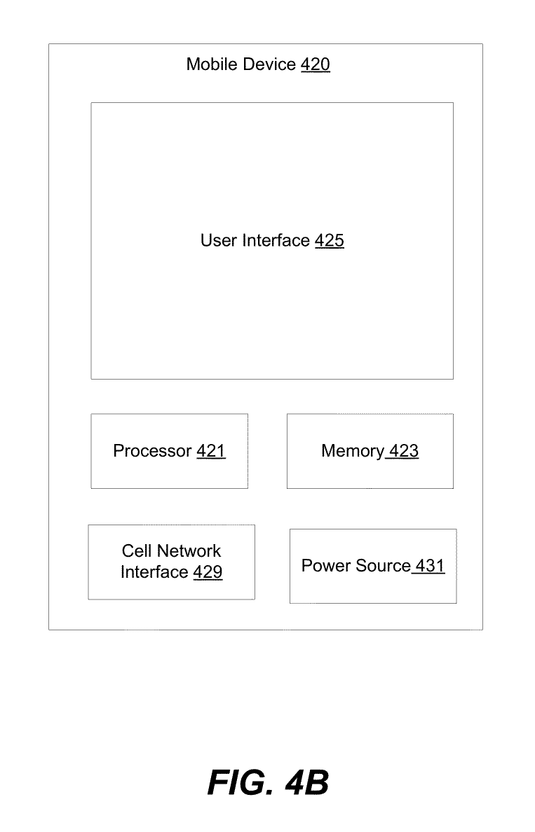

FIG. 4A illustrates a computer system that may be configured or designed for performing various operations describe above, in accordance with certain embodiments. The computer system 400 includes any number of processors 402 (also referred to as central processing units, or CPUs) that are coupled to storage devices including primary storage 406 (typically a random access memory, or RAM), primary storage 404 (typically a read only memory, or ROM). CPU 402 may be of various types including microcontrollers and microprocessors such as programmable devices (e.g., CPLDs and FPGAs) and unprogrammable devices such as gate array ASICs or general purpose microprocessors. Primary storage 404 may act to transfer data and instructions uni-directionally to the CPU and primary storage 406 is used typically to transfer data and instructions in a bidirectional manner. Both of these primary storage devices may include any suitable computer-readable media such as those described above. A mass storage device 408 is also coupled bi-directionally to CPU 402 and provides additional data storage capacity and may include any of the computer-readable media described above. Mass storage device 408 may be used to store programs, data and the like and is typically a secondary storage medium such as a hard disk. It will be appreciated that the information retained within the mass storage device 408, may, in appropriate cases, be incorporated in standard fashion as part of primary storage 406 as virtual memory. A specific mass storage device such as a CD-ROM 414 may also pass data uni-directionally to the CPU.

CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications network using an external connection as shown generally at 412. With such a connection, it is contemplated that the CPU might receive information from the network, or might output information to the network in the course of performing the operations described herein.

The example embodiments described herein may be implemented in an operating environment including software installed on a computer, in hardware, or in a combination of software and hardware.

FIG. 4B illustrates a particular example of a mobile device 420. The mobile device 420 includes a processor 421, a memory 423, a user interface 425, a cellular network interface 429, and a power source 431. A processor 421 may be specifically configured to encode various information into one or more barcodes from the product codes. A user interface 425, such as an LCD screen, is configured to display one or more barcodes. Different product information, e.g., retrieves from the product code and/or received from the payment server. Memory 423 may be configured to store various security features associate with the transaction. Furthermore, advanced processing, communicating, scanning and displaying capabilities of the mobile devices and more frequent use of these capabilities may need substantial power outputs provided by the power source 431.

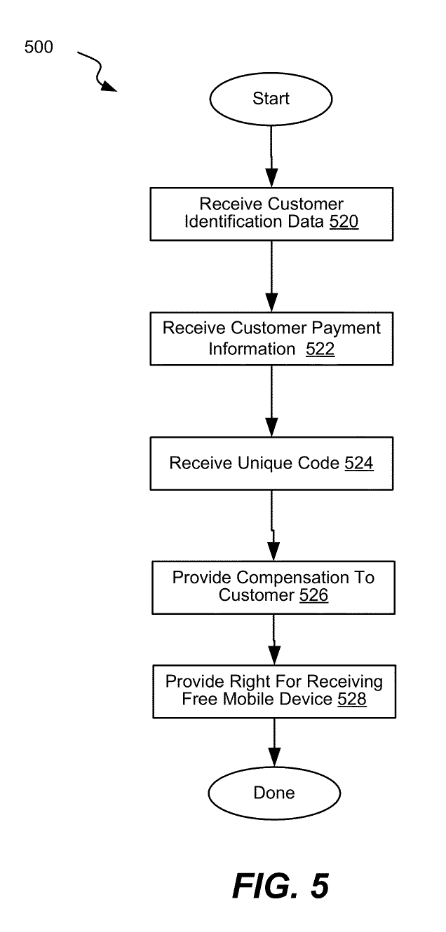

FIG. 5 is a flow chart illustrating a method for receiving compensation for using mobile payment services, in accordance with certain embodiments.

The method 500 may commence at receiving customer identification data at operation 520. A customer may activate an application on his mobile device and register with a mobile payment service provider. Thereafter, the method 500 may proceed with receiving customer payment information at operation 522. The customer payment information may include information associated with a bank checking account, a credit card, a debit card, a gift card, cash, or digital money. Based on the customer payment information, the method 500 may further proceed with receiving a unique code at operation 524. The unique code may encode data associated with the customer payment information. The unique code may include any linear or two-dimensional code and may be scannable by a scanner of a merchant to transfer payment for products. In certain embodiments, the unique code may be scanned by a mobile device with scanning capability. In certain embodiments, upon transferring the payment for products, the customer may receive an email receipt confirming a purchase made. The email receipt may contain detailed information associated with a credit amount or a cashback amount.

The method 500 may also include providing compensation to the customer at operation 526. The compensation may be provided to the customer according to predetermined criteria. The predetermined criteria may include providing information on a bank checking account, participating in affiliate marketing and loyalty programs, participating in group buying offers made by a mobile network operator, a mobile device company, or other merchants.

Upon providing the compensation to the customer, the method 500 may further proceed with providing a right for receiving a free mobile device at operation 528. An amount of compensation received by the customer may entitle him to receive a free mobile device from the mobile payment service provider. In certain embodiments, the customer may also receive a free mobile device without monthly fee for mobile services. Additionally, the customer may also receive free insurance services and/or free bank services from a bank of the mobile payment service provider, or may save payment card charges upon providing bank checking account information at operation 522. In certain embodiments, the free bank services may include early account closure fee, monthly or annual maintenance fee, minimum balance fee, refundable deposit fee, foreign transaction fee, lost debit card fee, bank statement fee, redeemed rewards points fee, retained mail fee, refundable mail fee, help desk fee, wire transfer fee, stop payment fee. In certain embodiments, the free bank services may be provided by a related bank or a bank of the mobile payment service provider.

In certain embodiments, the free insurance services may include life insurance, health insurance, property insurance, liability insurance, or casualty insurance. Besides, the free insurance services may be provided by an insurance company of the mobile payment service provider.

Furthermore, the customer may exchange his mobile device for a new one free of charge. In certain embodiments, the customer may also receive spare parts for the mobile device free of charge or may receive services for free repair of the mobile device.

In certain embodiment, if the amount of compensation is not enough for receiving the free mobile device, the mobile payment service provider may withdraw funds from a customer account.

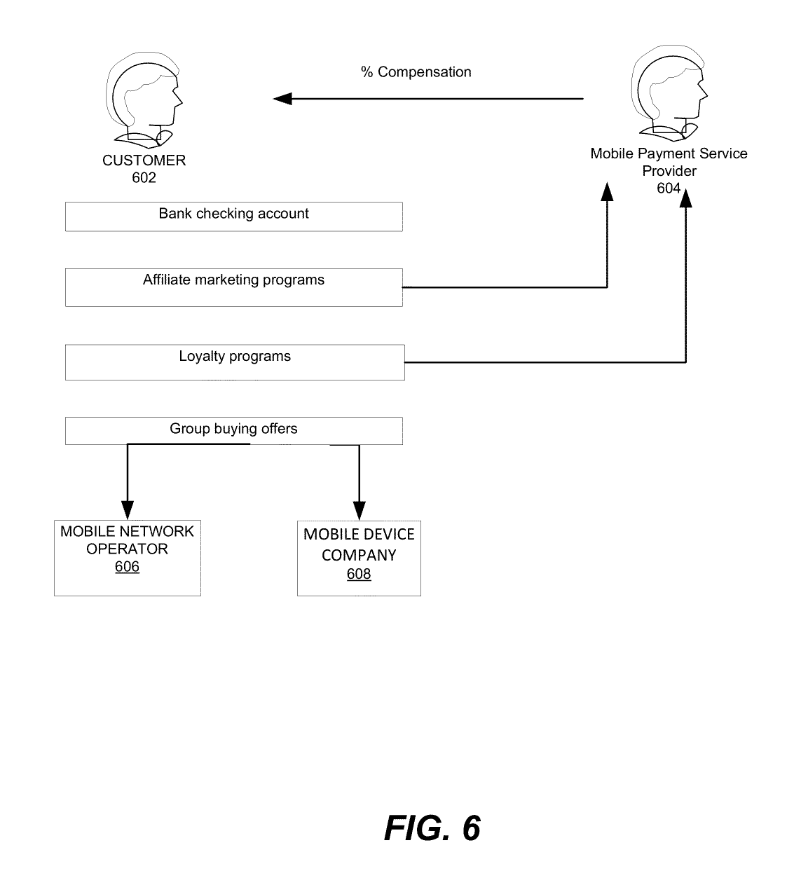

FIG. 6 is a block diagram illustrating an example of overall system for receiving compensation for using mobile device payment services, in accordance with certain embodiments.

As shown in FIG. 6, a customer 602 may provide his bank checking account information upon registration with a mobile payment service provider 604 or participate in affiliate marketing programs, loyalty programs of the mobile payment service provider 604 and receive a predetermined amount of compensation. The customer may also participate in group buying offers made by a mobile network operator 606 or a mobile device company 608 and receive further predetermined amount of compensation.

The compensation may include providing loyalty credits for participation in loyalty programs, repaying a percentage of an amount of purchases made with the mobile payment service provider, providing a refund of bank services and/or a discount on mobile services, providing zero monthly fee, or free bank services. In certain embodiments, the compensation may also include saved payment card charges when providing data related to a bank checking account. A high amount of compensation may entitle the customer to receive free insurance services and/or free bank services from a bank of the mobile payment service provider.

Thus, various systems and methods for purchasing for a product item in a retail environment using a mobile device and a payment server have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A method for receiving compensation for using mobile payment services:
receiving, from a customer, identification data to indentify the customer with a mobile payment service provider;
receiving customer payment information;
based on the customer payment information, receiving a unique code, the unique code being scannable by one or more of the following: a scanner of a merchant, a further mobile device with scanning capability;
selectively providing a compensation to the customer based on predetermined criteria; and
based on the compensation, providing a right for receiving a free mobile device from the mobile payment service provider or related provider.

2. The method of claim 1, wherein the customer payment information includes one or more of the following: bank checking account information, credit card information, debit card information, gift card information, cash, and digital money.

3. The method of claim 1, wherein the customer receives an email receipt upon purchasing one or more products, the email receipt containing detailed information associated with one or more of the following: a credit amount, a cashback amount.

4. The method of claim 1, wherein the predetermined criteria include one or more of the following: providing information on the bank checking account, participating in affiliate marketing and loyalty programs, participating in group buying offers.

5. The method of claim 4, wherein the group buying offers are made by one or more of the following: a mobile network operator, a mobile device company, and any other merchant.

6. The method of claim 1, wherein the unique code includes one or more of the following: a linear barcode, a two-dimensional barcode, and any other barcode.

7. The method of claim 1, wherein the compensation includes one or more of the following: loyalty credits provided for participation in loyalty programs, a repayment of a percentage of an amount of purchases made with the mobile payment service provider, a refund of bank services, a discount on mobile services, free mobile services, zero monthly fee, free bank services, free insurance services, saved payment card charges.

8. The method of claim 7, wherein the free bank service include one or more of the following: early account closure fee, monthly or annual maintenance fee, minimum balance fee, refundable deposit fee, foreign transaction fee, lost debit card fee, bank statement fee, redeemed rewards points fee, retained mail fee, refundable mail fee, help desk fee, wire transfer fee, stop payment fee.

9. The method of claim 7, wherein the free bank services are provided by one or more of the following: a related bank, a bank of the mobile payment service provider.

10. The method of claim 7, wherein the free insurance services include one or more of the following: life insurance, health insurance, property insurance, liability insurance, and casualty insurance.

11. The method of claim 7, wherein the free insurance services are provided by an insurance company of the mobile payment service provider or related insurance company.

12. The method of claim 1, wherein the customer receives services for one or more of the following: free repair of the mobile device, free exchange of the mobile device, free receipt of spare parts for the mobile device, free of dongles charges by scanning payment cards information, and free of monthly phone fee.

13. A system for receiving compensation for using mobile payment services, the system comprising a processor configured to:
receive, from a customer, identification data to indentify the customer with a mobile payment service provider;
receive customer payment information;
based on the customer payment information, receive a unique code, the unique code being scannable by a scanner of a merchant;
selectively provide a compensation to the customer based on predetermined criteria; and
based on the compensation, provide a right for receiving a free mobile device from the mobile payment service provider, the free mobile device.

14. The system of claim 13, wherein the customer payment information includes one or more of the following: bank checking account information, credit card information, debit card information, and gift card information.

15. The system of claim 13, wherein the system includes one or more of the following: a mobile virtual wallet, an SMS payment, direct mobile billing, a mobile web payment(WAP), a contactless NFC, an online wallet, an audio signal mobile payment, a direct mobile carrier/bank co-operation, a mobile operator-centric model, a bank-centric model, and a peer to peer model.

16. The system of claim 13, wherein the predetermined criteria include one or more of the following: providing information on the bank checking account, participating in affiliate marketing and loyalty programs, participating in group buying offers made by a mobile network operator or a mobile device company.

17. The system of claim 13, wherein the unique code is a linear barcode or a two-dimensional barcode.

18. The system of claim 13, wherein the customer payment information is stored in one or more of the following: a memory of the mobile device, a secured server.

19. The system of claim 13, wherein the compensation includes one or more of the following: loyalty credits provided for participation in loyalty programs, a repayment of a percentage of an amount of purchases made with the mobile payment service provider, a refund of bank services, a discount on mobile services.

20. The system of claim 13, wherein the customer replaces the mobile device free of charge.

21. The system of claim 13, wherein the customer receives spare parts for the mobile device free of charge.

22. The system of claim 13, wherein the mobile device of the customer is repaired free of charge.

23. A computer-readable medium comprising instructions, which when executed by one or more processors, perform the following operations:
receive, from a customer, identification data to indentify the customer with a mobile payment service provider;
receive customer payment information;
based on the customer payment information, receive a unique code, the unique code being scannable by a scanner of a merchant;
selectively provide a compensation to the customer based on predetermined criteria; and
based on the compensation, provide a right for receiving a free mobile device from the mobile payment service provider.
